(19) United States
(12) Patent Application Publication
(10) Pub. No.: US 2004/0130564 A1
(43) Pub. Date: Jul. 8, 2004

(54) Software tool for providing a demonstration screen

(76) Inventor: Alan G. Smith, Allen, TX (US)

Correspondence Address: TEXAS INSTRUMENTS INCORPORATED, P O BOX 655474, M/S 3999, DALLAS, TX, 75265

(21) Appl. No.: 10/335,773

(22) Filed: Jan. 2, 2003

(51) Int. Cl. G09G 5/00

(52) U.S. Cl. 345/705; 345/864

(57) ABSTRACT

An embodiment of the present invention may provide a software tool adapted to run on a handheld computer for providing a mock-up graphical user interface on a display screen of the handheld computer for use in demonstrating the look and feel of a proposed software product. A demonstration file adapted to be executed on a handheld computer device may include sets of screen instructions for providing at least two of the screen displays. At least one of the sets of screen instructions includes a screen name, a jump reference, and at least one text anchor element and/or at least one image anchor element. A text anchor element and/or an image anchor element uses an absolute screen position specification providing an absolute pixel location for specifying a location on the screen for placement of text and/or an image. Preferably the demonstration file is formatted as a well-formed XML document.

### TECHNICAL FIELD

The present invention relates generally to a software tool for providing a demonstration screen. In one aspect, the present invention relates to a software tool adapted to run on a handheld computer to provide a mock-up graphical user interface on a display screen of the handheld computer for use in demonstrating the look and feel of a software product.

### BACKGROUND

When developing or designing a user interface for a software product, it is often desired to test the reaction of typical users in a test group to determine whether the user interface is intuitive, user friendly, comprehensive, too complex, useful, and/or attractive to the users. In the past user interface developers would sometimes generate multiple sheets of paper to represent multiple screens. Using the paper sheets, the developer would then ask the tester to simulate what he or she would click on or choose to obtain a desired result or to navigate through the screens. However, using sheets of paper in this manner is not a very effective simulation to gauge the test user's reactions nor for the test user to give accurate feedback about the look and feel of the user interface.

Other developers in the past would proceed with developing the user interface and the software product to a point where the software product is usable or partially usable, and then get test users to evaluate the user interface. However, this method is often not preferable because if the test users recommend that something should be changed or added on the user interface, it may be difficult, expensive, and/or very time consuming for the developer to modify the user interface at that point. Also, test users often identify needs and useful features during testing that the developer may not have thought of or may not have realized was important. Furthermore, the test users may comment that a certain proposed idea for a software product is not useful, not practical, and/or not desired by the test users, even though the developers or engineers may have initially thought the idea was beneficial. Hence, there is a need for a way to provide a mock-up or simulation of an actual user interface on screen in an efficient manner to allow the developer to obtain input from test users prior to investing substantial time and money into the development of the actual software product.

### SUMMARY

The problems and needs outlined above are addressed by embodiments of the present invention. In accordance with one aspect of the present invention, a method of providing demonstration screen displays on a display screen of a handheld computer device, is provided. The method includes the following steps. A demonstration file is executed on the handheld computer device. The demonstration file includes sets of screen instructions for providing at least two of the screen displays. At least one of the sets of screen instructions includes a screen name, a jump reference, and at least one text anchor element and/or at least one image anchor element. The screen name is for identifying the set of screen instructions. The jump reference is to any one of the screen names in the demonstration file. Each text anchor element includes an opening text anchor tag, a text string content, an absolute screen position specification, and a closing text anchor tag. The opening text anchor tag signifies the beginning of the text anchor element. The absolute screen position specification specifies where the text string content is placed on the display screen. The closing text anchor tag signifies the end of the text anchor element. Each image anchor element includes an opening image anchor tag, an image file name, an absolute screen position specification, and a closing image anchor tag. The opening image anchor tag signifies the beginning of the image anchor element. The image file name corresponds to an image file having data for an image therein. The absolute screen position specification specifies where the image is placed on the display screen. The closing image anchor tag signifies the end of the image anchor element. A first graphical user interface is generated and displayed on the display screen while executing the demonstration file on the handheld computer device. The first graphical user interface corresponds to a first screen name selected from any one of the screen names. The first graphical user interface is generated and displayed based on the set of screen instructions identified by the first screen name.

In accordance with another aspect of the present invention, a method of providing demonstration screen displays on a display screen of a handheld computer device, is provided. The method includes the following steps. A demonstration file is executed on the handheld computer device. The demonstration file includes sets of screen instructions for providing at least two of the screen displays. At least one of the sets of screen instructions includes a screen name, and at least one text anchor element and/or at least one image anchor element. The screen name is for identifying the set of screen instructions. Each text anchor element includes an opening text anchor tag, a text string content, an absolute screen position specification, and a closing text anchor tag. The opening text anchor tag signifies the beginning of the text anchor element. The absolute screen position specification specifies where the text string content is placed on the display screen. The closing text anchor tag signifies the end of the text anchor element. Each image anchor element includes an opening image anchor tag, an image file name, an absolute screen position specification, a jump reference, and a closing image anchor tag. The opening image anchor tag signifies the beginning of the image anchor element. The image file name corresponds to an image file having data for an image therein. The absolute screen position specification specifies where the image is placed on the display screen. The jump reference links at least part of the image to any one of the screen names in the demonstration file. The closing image anchor tag signifies the end of the image anchor element. A first graphical user interface is generated and displayed on the display screen while executing the demonstration file on the handheld computer device. The first graphical user interface corresponds to a first screen name selected from any one of the screen names. The first graphical user interface is generated and displayed based on the set of screen instructions identified by the first screen name. A first user input is accepted via the first graphical user interface. The first user input calls upon a first jump reference selected from a jump reference in the set of screen instructions of the first screen name. The first jump reference is to a second screen name selected from any one of the screen names in the demonstration file. The first graphical user interface is removed from the display screen. A second graphical user interface is generated and displayed on the display screen. The second graphical user interface corresponds to the second screen name. The second graphical user interface is generated and displayed based on the set of screen instructions identified by the second screen name.

A text anchor element may further include a font specification for the text string content, and/or a screen width specification for the text string content. The screen width specification provides an instruction as to where the text string content shall be wrapped to a next line. A jump reference may be embedded in one of the text anchor elements for linking the jump reference to its text string content. An image anchor element may further include a shape specification for a button area on the image corresponding to the jump reference, and/or an absolute screen position specification for defining boundaries of the button area. Also, an image anchor element may further include an image anchor specification for specifying which location on the image will be placed at the specified absolute screen position for the image.

In accordance with yet another aspect of the present invention, a handheld computer device is provided, which includes a display screen, an operating system, and a user input device. The operating system is adapted to execute a demonstration file on the handheld computer device. The demonstration file includes sets of screen instructions for providing at least two screen displays. At least one of the sets of screen instructions includes a screen name, a jump reference, and at least one text anchor element and/or at least one image anchor element. The screen name identifies the set of screen instructions. The jump reference is to any one of the screen names in the demonstration file. Each text anchor element includes an opening text anchor tag, a text string content, an absolute screen position specification, and a closing text anchor tag. The opening text anchor tag signifies the beginning of the text anchor element. The absolute screen position specification specifies where the text string content is placed on the display screen. The closing text anchor tag signifies the end of the text anchor element. Each image anchor element includes an opening image anchor tag, an image file name, an absolute screen position specification, and a closing image anchor tag. The opening image anchor tag signifies the beginning of the image anchor element. The image file name corresponds to an image file having data for an image therein. The absolute screen position specification specifies where the image is placed on the display screen. The closing image anchor tag signifies the end of the image anchor element. The handheld computer device is adapted to generate and display a first graphical user interface on the display screen while executing the demonstration file. The first graphical user interface corresponds to a first screen name selected from any one of the screen names. The first graphical user interface is generated and displayed based on the set of screen instructions identified by the first screen name. The user input device is for allowing a user to interact with the first graphical user interface. The display screen may be a touch-sensitive screen or a LCD display, for example. The user input device may include a stylus, buttons adjacent to the display screen, an external keyboard, a cursor control device adjacent to the display screen, an external cursor control device or any combination thereof, for example.

### BRIEF DESCRIPTION

For a more complete understanding of the present invention, and the advantages thereof, reference is now made to the following descriptions taken in conjunction with the accompanying drawings, in which:

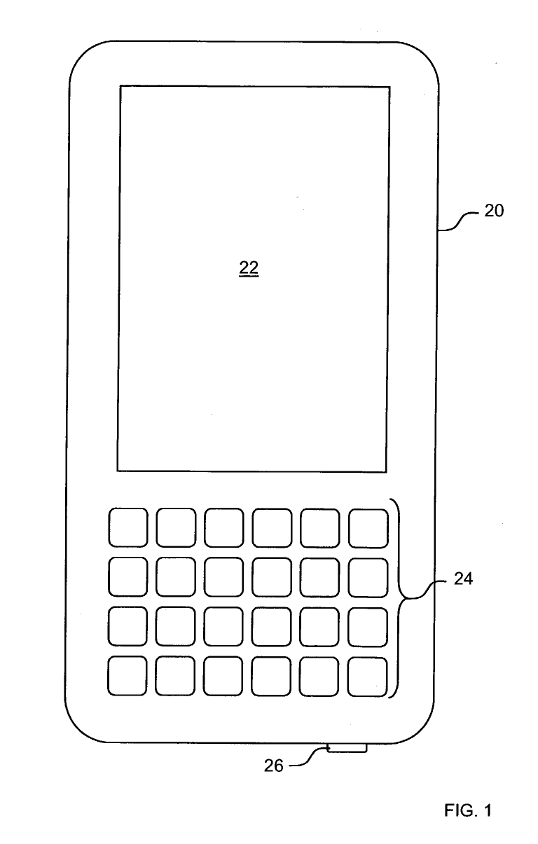

FIG. 1 is a simplified diagram of a handheld computer device of a first embodiment;

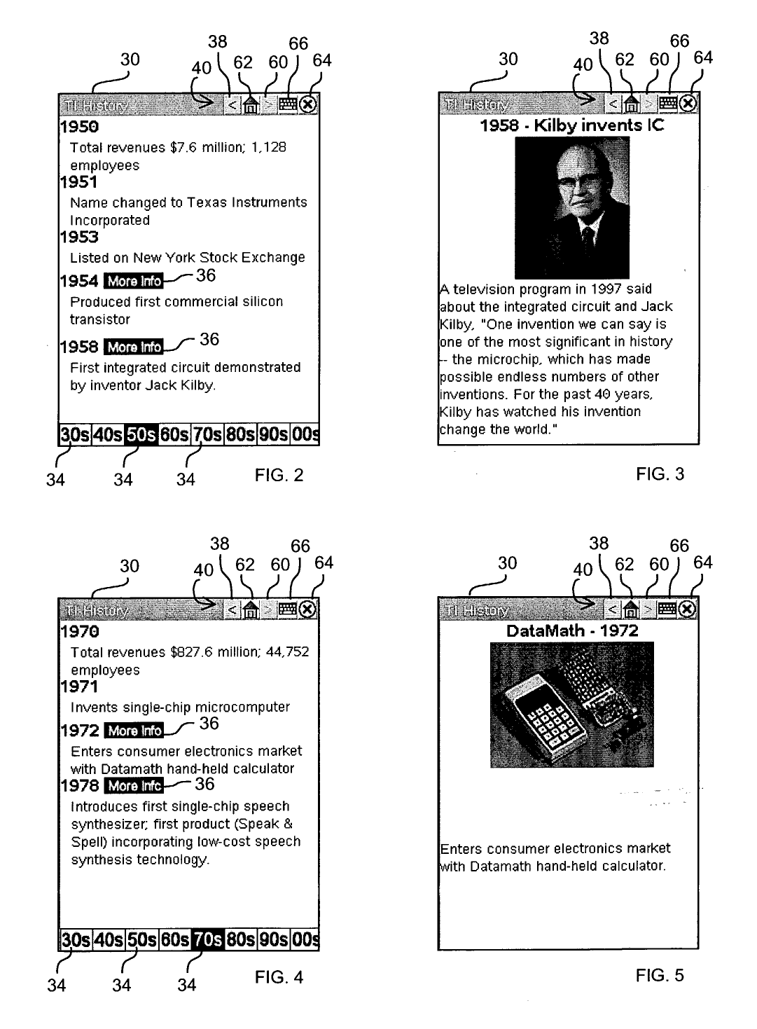

FIGS. 2-5 are some example screen shots of the first embodiment being displayed on the handheld computer device of FIG. 1;

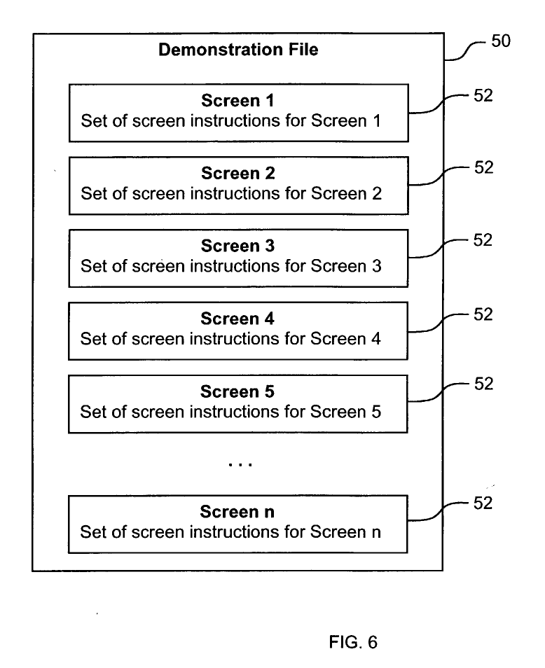

FIGS. 6-10 provide some simplified and generalized diagrams illustrating the structure and architecture of a demonstration file of the first embodiment;

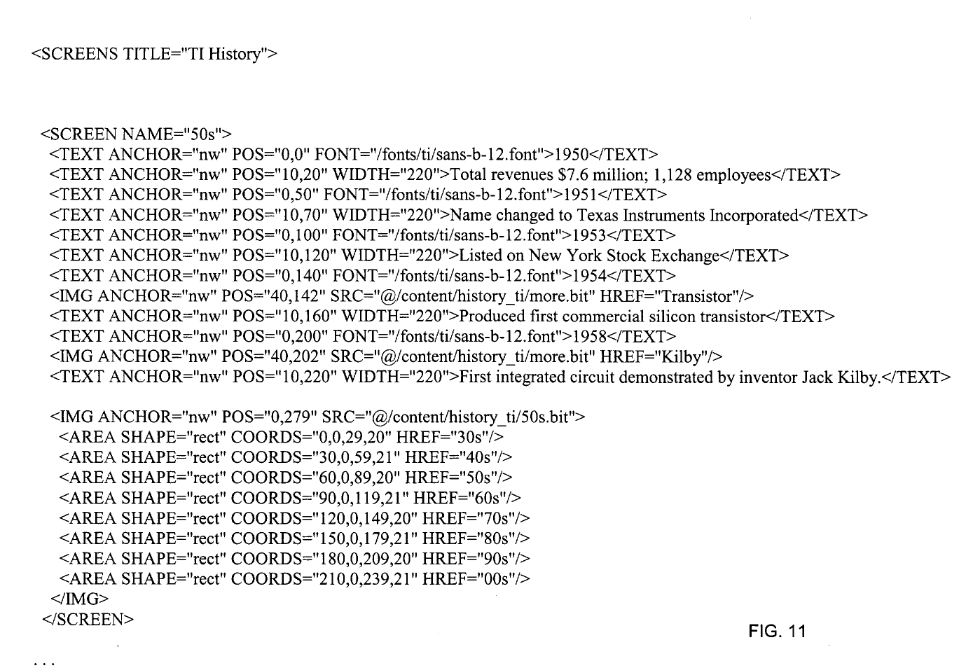

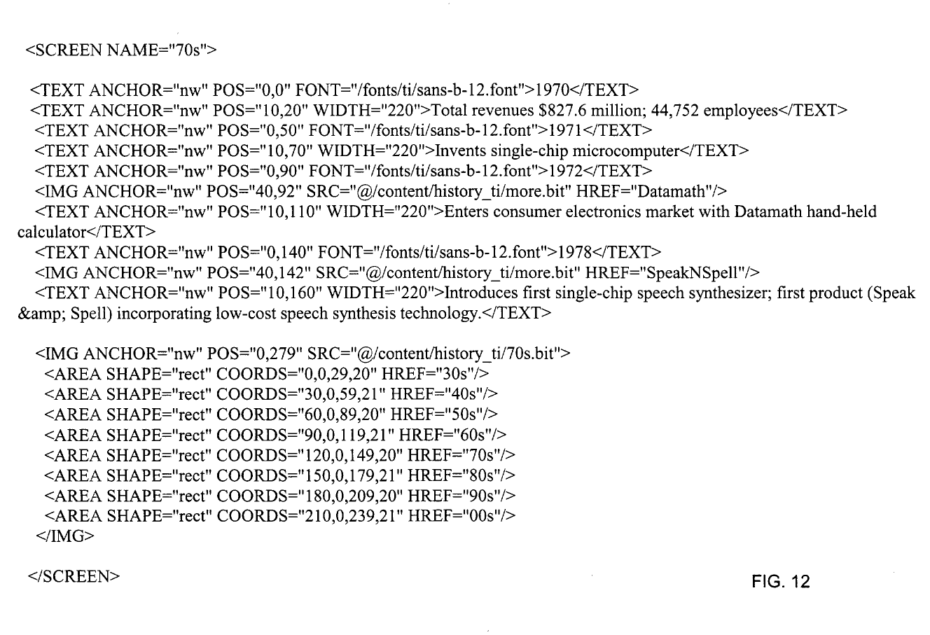

FIGS. 11-14 provide excerpts from the actual demonstration file used to generate the screens shown in FIGS. 2-5; and

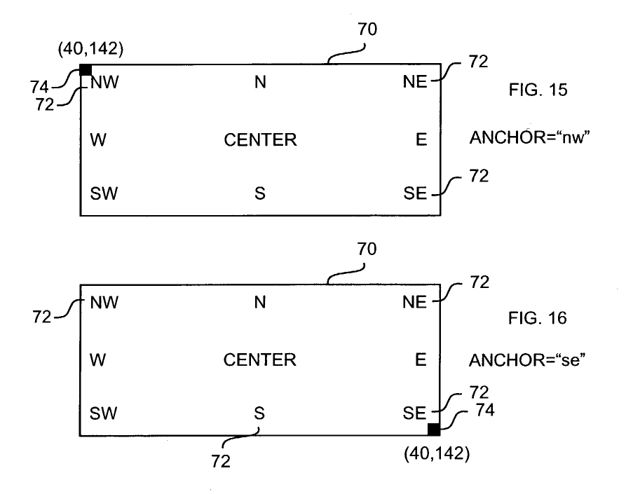

FIGS. 15 and 16 are simplified schematics representing an image and an absolute pixel location specification for the image.

### DETAILED DESCRIPTION

Referring now to the drawings, wherein like reference numbers are used herein to designate like elements throughout the various views, a preferred embodiment of the present invention is illustrated and described, and other possible embodiments of the present invention are described. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention generally relates to a software tool for providing a demonstration screen. In one aspect, the present invention relates to a software tool adapted to run on a handheld computer to provide a mock-up graphical user interface on a display screen of the handheld computer for use in demonstrating the look and feel of a proposed software product. Examples of handheld computers include, but are not necessarily limited to: graphical calculators, calculators with a multi-line screen, handheld-size limited-purpose computer devices, handheld-sized educational computer devices, handheld-sized portable computer device having a multi-line screen, portable computers, laptop computers, personal digital assistants (PDA), palmtop computers, personal communicators, personal intelligent communicators, cellular or mobile telephones having a multi-line screen, global positioning system (GPS) devices, portable inventor logging computer devices having a multi-line screen (as may be used by courier deliverers, for example), handheld monitoring devices having a multi-line screen (as may be used by meter readers, for example), handheld parking ticket administering devices having a multi-line screen, handheld portable email computer devices having a multi-line screen, handheld portable Internet browsing devices, handheld portable gaming devices, or any combination thereof, for example.

The following description and FIGS. 1-16 pertain to a first embodiment of the present invention. The first embodiment will be used herein to provide a simple example of the present invention and to explain by example various aspects of the present invention.

FIG. 1 illustrates a simplified top view of a handheld computer device 20. A handheld computer device typically has a multi-line display screen and a user input device. The handheld computer device 20 of FIG. 1 has a touch-sensitive display screen 22 adapted to accept inputs by touching the display screen 22 with an object (not shown), such as a stylus, a user's finger, or a writing utensil, for example. The handheld computer device 20 of FIG. 1 also has a button pad 24 located adjacent to the display screen 22.

A handheld computer device of other embodiments (not shown) may have one or more user input devices on the handheld computer 20 adjacent to the display screen 22, such as a numerical keypad, a cursor control device (e.g., trackball, touch-sensitive mouse pad), a keyboard, or any combination thereof, for example. A user input connection jack 26 is provided at the bottom of the handheld computer device 20 of FIG. 1. The user input connection jack 26 may be used to plug in external user input devices, such as a keyboard (not shown) and/or a cursor control device (e.g., mouse) (not shown), for example. In other embodiments (not shown), the handheld computer device may have a wireless user input device adapted to have a wireless connection to the device, such as an infrared red input port, an infrared communication port, a wireless mouse, and/or a wireless keyboard, for example. In yet another embodiment (not shown), the handheld computer device may only have a touch-sensitive screen as the user input device, with or without an input jack for other user input options.

The handheld computer device 20 of FIG. 1 has an operating system (e.g., Inferno® Operating System from Lucent Technologies' Bell Labs) adapted to run programs on the handheld computer device 20 and to provide graphical user interfaces on the display screen 22. Such handheld computer devices 20 typically have a microprocessor (not shown) and memory (e.g., SRAM, flash memory, DRAM, etc.) (not shown) therein for executing and storing software. Because a handheld computer device is typically battery operated, the usage of processor power is often minimized to extend the useful life of a power source (e.g., rechargeable battery).

One of the useful features of the present invention is the ability to provide demonstration screen displays on a display screen 22 of a handheld computer device 20. Such demonstration screen displays may provide a useful mock-up for testing a software product idea before investing the time and money into programming and developing a fully-developed program. Such demonstration screen displays may be useful in evaluating consumer response to the user interfaces and proposed functions of the software product idea being developed or being considered for development.

FIGS. 2-5 show some example screen shots of the first embodiment being displayed on a handheld computer device, such as the device 20 in FIG. 1. As will be described in further detail later, the demonstration displays 30 of FIGS. 2-5 are generated using a single demonstration file containing sets of instructions for multiple screens.

The operation of and navigation through the demonstration screen displays 30 of FIGS. 2-5 will be next described to provide a context for discussing the present invention. Referring to FIG. 2, some historical information is provided about Texas Instruments, Inc. (“TI” hereinafter) during the 1950's. At the bottom of the display 30, there are buttons 34 linking to other screens for other time periods (e.g., 30's, 40's, 50's, 60's, 70's, etc.). Also, there are some “More Info” buttons 36 on the display 30. Assuming the demonstration file in this example is running on the handheld computer device 20 of FIG. 1, a user may navigate among the screens 30 using a stylus. By touching any of the buttons 34, 36 on the display 30 of FIG. 2 with a stylus (i.e., clicking on a linked button), another screen display may be called upon and displayed. For example, if a user clicks on the “More Info” button 36 next to the 1958 header, the display 30 shown in FIG. 2 will be removed from the display screen 22, and then the display 30 shown in FIG. 3 will be generated and displayed on the display screen 22 of the device 20. The display 30 in FIG. 3 provides more information about the historical note for the year 1958 in FIG. 2. To return to the prior screen, the user may click on the back arrow button 38 in the upper tool bar 40.

Referring again to FIG. 2, if the user clicks on the 70s button 34 at the bottom of the display 30, the display 30 shown in FIG. 2 will be removed from the display screen 22 and then the display 30 shown in FIG. 4 will be generated and displayed on the display screen 22 of the device 20. The display 30 of FIG. 4 provides historical notes about TI for the 1970's years. In FIG. 4, if the user clicks on the “More Info” button 36 next to the 1972 header, the display 30 of FIG. 4 will be removed and the display 30 of FIG. 5 will be generated and displayed. The display 30 of FIG. 5 provides more information and an image for the DataMath calculator introduced in 1972. If the user clicks on the back arrow 38 on the display 30 in FIG. 5, the display 30 of FIG. 5 will be removed and the display 30 of FIG. 4 will be generated and displayed again. In screen of FIG. 4, if the user clicks on the “50s” button 34 at the bottom of the display 30, the display 30 of FIG. 4 will be removed and the display 30 of FIG. 2 will be generated and displayed again. Thus, the user can navigate among different screens by clicking on buttons (e.g., buttons 34, 36, 38) providing links to other screens.

One thing to note about the screen displays 30 of the first embodiment is that there are no scroll bars (see e.g., FIGS. 2-5). For simplicity of demonstration in using the screens 30 and for simplicity of the program, the demonstration screen displays 30 of the first embodiment (FIGS. 2-5) are formatted to fit the display screen 22 of the device 20 in FIG. 1. If another device (not shown) having a different size screen 22 were used, the screen instructions may be modified to accommodate such screen. By doing so, the screen instruction remain relatively simple and streamlined for processor and memory efficiency.

In other embodiments (not shown), an image on a display may be that of a graph or chart, which could be displayed in response to a user selecting a certain button on a screen. Although the screen instructions in the demonstration file typically will not perform actual calculations, nor generate points on a plot, the demonstration screen displays could make it appear that such a computation and/or plot was performed to demonstrate how a proposed user interface may look and feel for another software application that actually performs calculations and plots data from such calculations, for example. Thus, through the use of thoughtful images and text, as well as the selection of screen display sequences, the demonstration screen displays may provide a user with a good feel for what the user interface may be like for a proposed software product. Also, such demonstration screen displays can be useful for proposing software functions to a test group to gauge the reaction of the test group users.

Next, the stricture and architecture of a demonstration file in accordance with the present invention will be discussed. In the first embodiment, the resulting demonstration displays 30 of FIGS. 2-5 are generated using a single demonstration file. FIGS. 6-10 provide some simplified and generalized diagrams illustrating the structure and architecture of a demonstration file 50 of the first embodiment. FIGS. 11-14 provide excerpts from the actual demonstration file 50 used to generate the screens 30 shown in FIGS. 2-5. As shown in FIGS. 11-14, the demonstration file 50 is preferably a well-formed XML document (i.e., following XML syntax rules). The use of XML is preferable because XML is expected to be a portable format useable for a long term and across many different platforms. Also, an XML parser is rapidly becoming a standard feature available on many operating systems and software applications being developed and offered today. However, other programming syntaxes and languages may be used. The instructions in FIGS. 11-14 only pertain to some of the screen instruction sets in the total demonstration file 50 (as noted by “ . . . ”). The total demonstration file 50 for the first embodiment has several more screen instruction sets for other screens, which are not shown. One of ordinary skill in the art having the benefit of this disclosure will realize other possible screens and variations that may be developed using the present invention.

Referring to FIG. 6, a demonstration file 50 includes sets of screen instructions 52 for providing multiple demonstration screen displays 30. Each set of instructions 52 is for generating and displaying a screen display 30. In the first embodiment, only one screen display 30 is displayed at a time. Each time a new screen is called upon, the current screen display is removed, as described above regarding the operation of the graphical user interfaces created by the demonstration file 50.

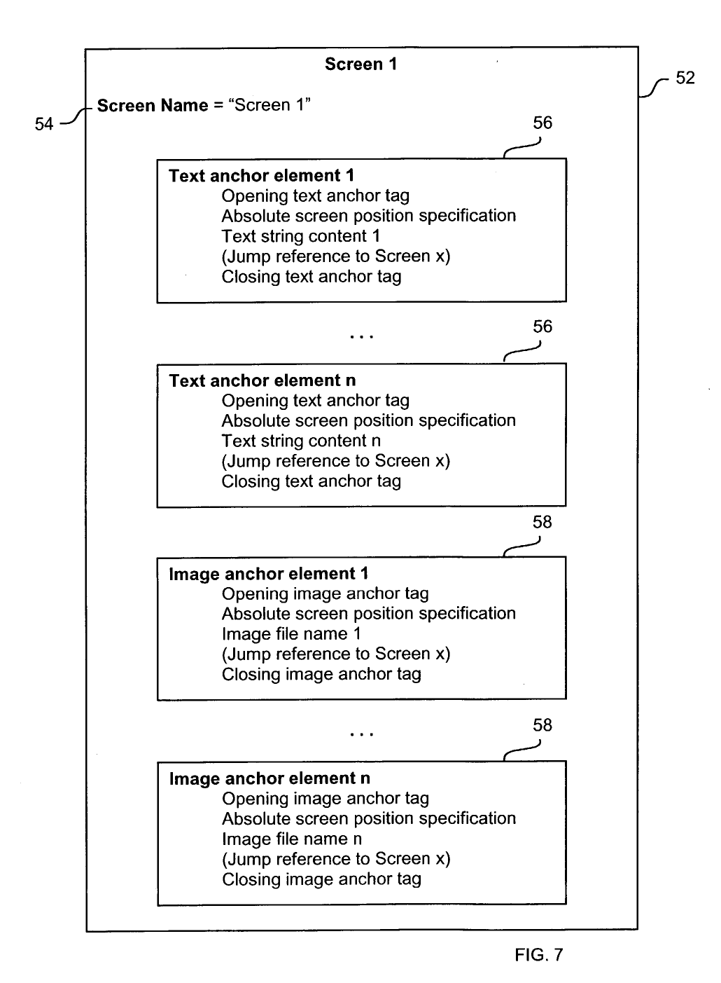

FIG. 7 provide more details about one of the sets of screen instruction 52 (Screen 1), for example. Each set of screen instructions 52 has a screen name 54 for identifying it and for calling upon it. Also, most sets of screen instructions 52 will include at least one text anchor element 56 and/or at least one image anchor element 58. Although generally not as useful, there may be a case (not shown) where one of the sets of screen instructions 52 has no text anchor element 56 and no image anchor element 58. Typically a set of screen instructions 52 will include both text and image anchor elements 56, 58. In general, the text anchor elements 56 specify the format, placement, and content of text that will be displayed on a given display 30, and the image anchor elements 58 specify the placement and image files that will be displayed on a given display 30. FIG. 7 illustrates the basic elements of text and image anchor elements 56, 58. FIG. 7 also illustrates that there may be any number (e.g., 0 to n) of text anchor elements 56 and any number (e.g., 0 to n) image anchor elements 58 in a given set of screen instructions 52.

Referring to FIG. 7, a text anchor element 56 of the first embodiment includes an opening text anchor tag, an absolute screen position specification, text string content, and a closing text anchor tag. Optionally, the text anchor element 56 may also include a jump reference to another screen 52 in the demonstration file 50. The opening text anchor tag signifies the beginning of the text anchor element 56. The closing text anchor tag signifies the end of the text anchor element 56. The text string content is the text and/or characters that will be placed on the display 30 and shown to the user.

The absolute screen position specification in the text anchor element 56 specifies where the text string content is placed on the display screen 22. The screen position specification is absolute because an absolute pixel location on the screen 22 is specified for where the text string content is placed. For example, in FIG. 11, the absolute pixel location for the second text anchor element of the “50s” screen is written as POS=“10,20”, which specifies the pixel x=10 and y=20 on the screen 22. Also in the second text anchor element of the “50s” screen, a text anchor specification written as ANCHOR=“nw” specifies that the top left corner of the text string content (i.e., “Total revenues $7.6 million; 1,128 employees” in this case) is placed at the absolute pixel location specified (i.e., POS=“10,20”).

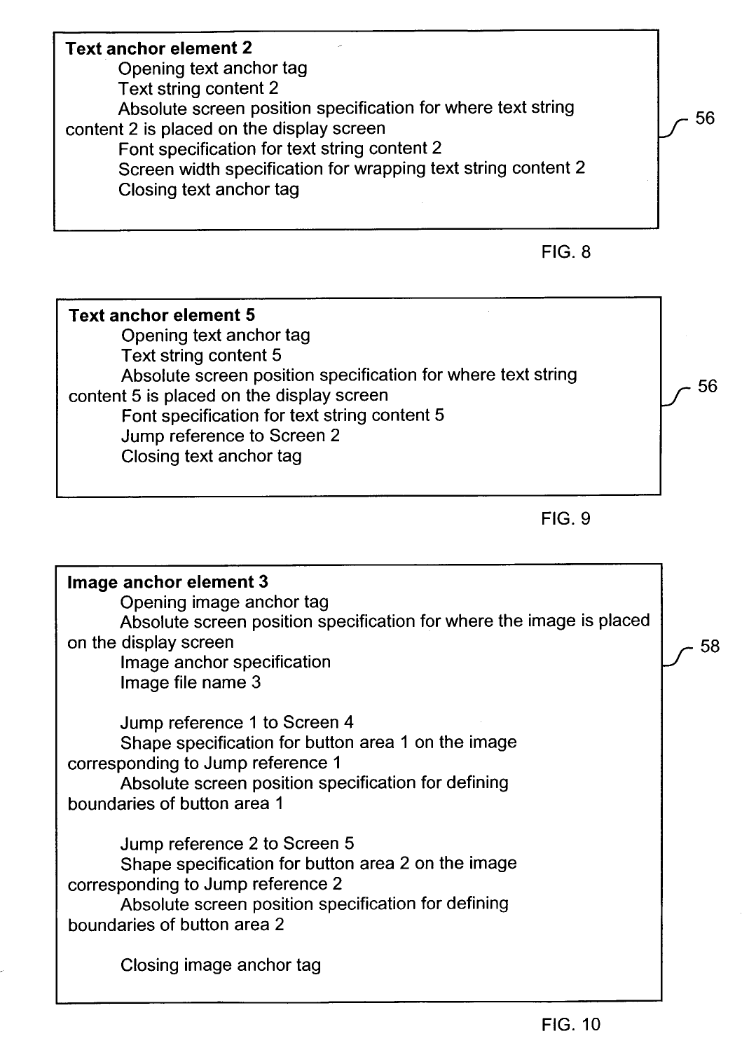

FIGS. 8 and 9 illustrate two example text anchor elements 56 from the screen 52 (Screen 1) in FIG. 7. In FIG. 8, the text anchor element 56 includes the basic elements shown in FIG. 7, plus a font specification and a screen width specification. The font specification and the screen width specification are optional elements that may be included in any text anchor element 56. Font specification specifies what font should be used for displaying the text string content of that text anchor element 56. For example, referring to the first text anchor element of the “50s” screen in FIG. 11, a font specification written as FONT=“/font/ti/sans-b-12 font” specifies that the text string content (i.e., “1950” in this case) should be displayed using the font file named “sans-b-12.font” at the specified path (i.e., “/font/ti/” in this case). Hence, each text anchor element 56 may specify that any of a variety of fonts be used for displaying its text string content.

The screen width specification provides an instruction as to where the text string content should be wrapped to a next line. Typically the screen width specification will be set to the pixel width of the screen 22 for a given device 20 (i.e., number of pixels a display screen 22 has across its width) or slightly less if a margin is desired. The screen 22 of the device 20 shown in FIG. 1, for example, has a screen width of 240 pixels. For example, referring to the second text anchor element of FIG. 11 again, the screen width specification is written as WIDTH=“220”. Hence, in this example, there is a right margin of 20 pixels. A width specification is useful when the length of the text string content exceeds the width of the screen 22 for a given device 20. If a screen width specification is used and if the length of the text string content is longer than the width of the screen 22, the text string content is drawn up to the screen width, the software backs up until it finds a space, comma, or hyphen, for example, and then it breaks the line and continues on a next line. The line height may be calculated based on the font used for that text string content. If the length of the text string content is longer than the width of the screen 22 and a screen width specification is not used, an end portion of the text string content will likely be cut off and not shown on the display screen 22. When the length of the text string content is less than the screen width for a given device 20, the screen width specification may not be need, and thus left out of the text anchor element 56.

In FIG. 9, the text anchor element 56 includes the basic elements shown in FIG. 7, plus a font specification and a jump reference to Screen 2. The jump reference makes the text string content for the text anchor element 56 become hyper-linked to another screen 52. Hence, for this example, if a user clicks on the text content string displayed for this text anchor element 56, the display of Screen 1 will be removed and the display of Screen 2 will be generated and displayed in accordance with the set of screen instructions for Screen 2 (not shown).

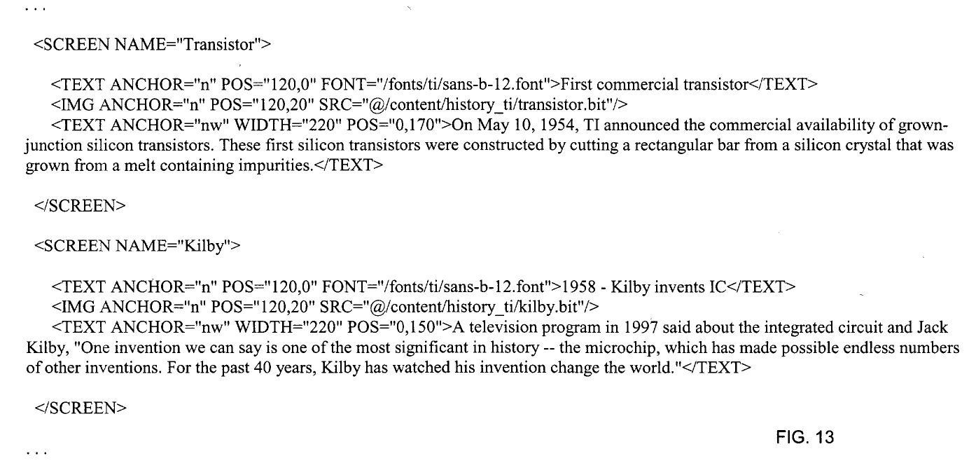

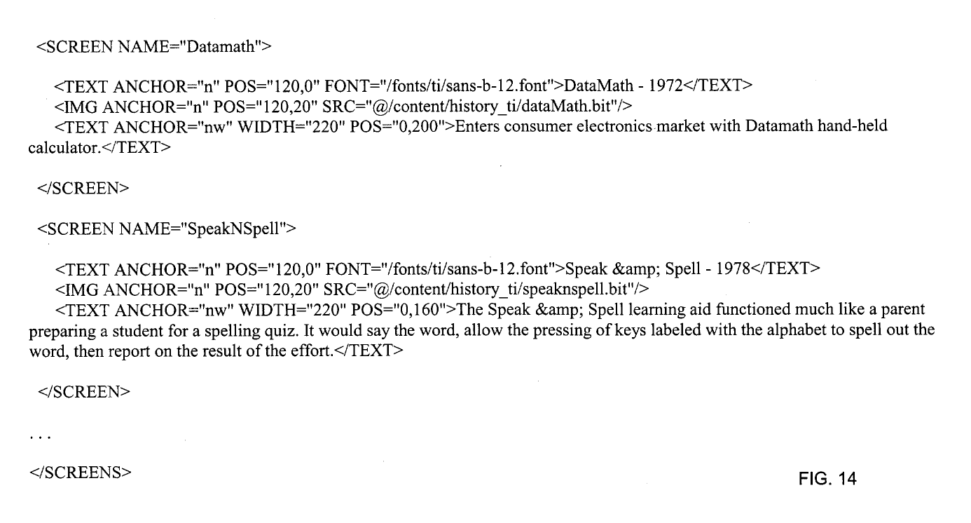

Each screen 52 preferably has some type of jump reference for navigating to at least one other screen 52. In a simple case, as in FIG. 3 for example, where there are not jump references associated with the text content nor with an image (see, e.g., the set of instructions for this screen at FIG. 13 under screen name=“Kilby”), the standard buttons on the toolbar 40 may provide the jump reference to another screen 52. In the first embodiment shown in FIGS. 2-5, the toolbar 40 includes a back button 38 (described above), a forward button 60, and a home button 62. When active, any of these toolbar buttons may provide a j ump reference to another screen 52. The toolbar 40 may also include other buttons, such as an exit button 64 and a keyboard button 66, as shown in FIGS. 2-5. In other embodiments (not shown), other button variations or combinations may be used in a toolbar 40. Preferably, there is always at least one button on the toolbar 40 in case a particular set of screen instructions 52 lacks a jump reference therein, as in the screen instructions (see e.g., FIGS. 13 and 14) for the displays 30 of FIGS. 3 and 5, for example. However, in other embodiments (not shown), there may be no toolbar buttons and no toolbar.

Referring again to FIG. 7, an image anchor element 58 of the first embodiment includes an opening image anchor tag, an absolute screen position specification, an image file name, and a closing image anchor tag. Optionally, the image anchor element 58 may also include a jump reference to another screen 52 in the demonstration file 50. The opening image anchor tag signifies the beginning of the image anchor element 58. The closing image anchor tag signifies the end of the image anchor element 58. The image file name corresponds to an image file having data for an image therein that will be placed on the display 30 and shown to the user.

FIG. 10 illustrates an example image anchor element 58 from the screen 52 (Screen 1) in FIG. 7. In FIG. 10, the image anchor element 58 includes the basic elements shown in FIG. 7, plus an image anchor specification, jump references, button shape specifications, and button boundary specifications.

The absolute screen position specification for where the image is placed on the screen 22 is similar to that of the text anchor element 56 (discussed above). An absolute pixel location on the screen 22 is specified for where the image from the image file will be placed on the screen 22. For example, in FIG. 11, the absolute pixel location for the first image anchor element of the “50s” screen is written as POS=“40,142”, which specifies the pixel x=40 and y=142 on the screen. Also in the first image anchor element of the “50s” screen, an image anchor specification written as ANCHOR=“nw” specifies that the top left corner of the image is placed at the absolute pixel location specified (i.e., POS-“40,142”). The image file name is this example is written as SRC=“@/content/history_ti/more.bit” to specify that the data for the desired image (i.e., the “More Info” button shown next to the 1954 header in FIG. 2) is located in an image file (i.e., “more.bit” in this case) at the specified path (i.e., “@/content/history_ti/” in this case).

FIGS. 15 and 16 illustrate the use of the image anchor specification. In each of FIGS. 15-16, a box 70 representing an image is shown. The image box 70 is labeled with direction coordinates 72 (e.g., NW, N, NE, E, SE, CENTER, etc.) corresponding to different positions on the image. For example, NW (northwest) designates the upper left corner of the image, and SE (southeast) designates the bottom right corner of the image. Hence, if an image anchor element has an absolute screen position specification of POS=“40,142” and an image anchor specification of ANCHOR=“nw”, as in the first image anchor element of FIG. 11, the upper left corner of the image will be placed at the pixel 74 having a coordinate of (40, 142) (e.g., in an inverted x-y plane of a Cartesian coordinate system with the origin in the top left corner of the screen), as shown in FIG. 15. If it were instead desired that the bottom right corner of the image be placed at the same pixel 74 (at coordinate 40, 142), then the image anchor specification of ANCHOR=“se” may be substituted for ANCHOR=“nw”, as illustrated in FIG. 16.

Referring back to FIG. 10, each jump reference calls to one of the screens 52 in the demonstration file 50. The jump references in Image anchor element 3 of FIG. 10 are associated with buttons. A display button in this context is essentially a bounded area of pixels on the screen 22 that provide a link to another screen 52 (i.e., when a jump reference is associated with the button). A text phrase may be designated as a button. An entire image may be designated as a button (see e.g., “More Info” button 36 in FIG. 2). And, one image may be split into multiple buttons (see e.g., buttons 34 in FIG. 2). Hence, a button may be defined anywhere on the screen 22. Also, a button may have any of a variety of possible shapes, including but not necessarily limited to: square, rectangular, round, oval, or polygonal, for example.

In Image anchor element 3 of FIG. 10, Jump reference 1 is a jump to Screen 4, and Jump reference 1 is assigned to Button area 1, which is defined by its shape specification and its boundary specifications. Similarly in FIG. 10, Jump reference 2 is a jump to Screen 5, and Jump reference 2 is assigned to Button area 2. Button area 2 is defined by its shape specification and its boundary specifications. In this example in FIG. 10, Button areas 1 and 2 are within an image provided by Image file name 3. However, in other embodiments, the button areas may extend beyond the image area or may not even overlap with the image area, for example.

A shape specification for a button area specifies the geometric shape of the button area. The absolute screen position specification for defining the boundaries of the button area are in absolute pixel coordinate locations relative to the pixel placement location for the image. For example, in the third image anchor element in FIG. 11 (which specifies the image and buttons 34 at the bottom of the display 30 shown in FIG. 2), the button shape specification for the “30s” button is written as AREA SHAPE=“rect” to designate a rectangular shape for the button area. Also for the “30s” button in FIG. 11, the button area boundaries for the rectangle are written as COORD=“0,0,29,20”, which represents a pixel coordinate (x=0,y=0) for an upper left corner of the button area relative to the absolute pixel coordinate (POS=“0,279”) for the image and a pixel coordinate (x=29,y=20) for a lower right corner of the button area relative to absolute pixel coordinate (x=0,y=279) for the image.

Referring again to FIG. 11 for another example, the jump reference for the “70s” button (at COORDS=“1120,0,149,20”) is written as HREF=“30s ”, which makes a jump reference to the screen named “70s” (shown in FIG. 4). The portion of the demonstration file 50 providing the set of screen instructions 52 for the screen named “70s” is shown in FIG. 12.

Referring to FIG. 11, the demonstration file 50 has a title of “TI History”. The documentation file title is written as <SCREENS TITLE=“TI History”> in FIG. 11, which signifies the beginning of the demonstration file 50. The end of the demonstration file 50 is signified by the last tag in FIG. 14, which is written as </SCREENS>.

One of the advantages provided by an embodiment of the present invention is ease of being able to generate a set of demonstration screen displays for testing a user interface. Another advantage provided by an embodiment of the present invention is the reduced amount of memory and processor power usage needed for storing and running a screens player program used to parse and display a demonstration file, as compared to a browser for displaying an HTML file, for example. Often, the larger the file size, the more processing power and RAM it will take to run the program. For instance, the memory space required to store a screen player program (which is preferably a limited-function program specifically tailored to only parse and display a demonstration file in accordance with the present invention) of the first embodiment example is only about 8,427 bytes. Whereas, an executable browser program (e.g., HTML browser for Inferno®) needed to display HTML files providing comparable screen displays requires about 318,537 bytes of memory storage space. That is a significant difference in storage space—about 3780% less storage space required for the first embodiment. Many handheld computer devices have limited storage capacity that is not expandable. Thus, a smaller program size may be beneficial for a device by freeing up memory storage space for other programs and/or by allowing the device to have less memory therein.

In addition, the single demonstration file of the first embodiment generates similar results on-screen, as that of about 23 HTML files. Another advantage of an embodiment of the present invention is that each time a new screen is called upon, the same demonstration file that is already running is used to generate the new screen. Hence, another file for the screen does not need to be loaded and processed, as is frequently done when using HTML files on an HTML browser. Also, generating multiple screens from a single demonstration file makes switching between screens much quicker than if another file were opened each time a screen selection changes. Thus, when a user clicks on a button to jump to another screen, the next screen comes up fast and the user is not left waiting for another screen file to load. This also equates to a more efficient use of processor power. Using less processor power may prolong battery life. Also, requiring less processor speed or capacity may free tip processing capacity for other tasks and/or may allow for the use of a slower or less powerful processor on the device.

Another advantage to the structure and architecture of the demonstration file is the reduced amount of random access memory (RAM) required to run and generate the screen displays using the screen player program. For example, a display generated and displayed from the demonstration file of the first embodiment requires only about 475,200 bytes of RAM usage. In comparison, to generate the same screen display on an HTML browser using HTML code requires about 2,380,752 bytes of RAM usage. That is a significant difference in RAM usage—about 500% less RAM usage for the first embodiment. Less RAM usage may provide faster processing. Also, by requiring less RAM usage, the remaining RAM may be used for other tasks and/or the device may be made with less total RAM. Reducing the total amount of RAM in a device should reduce the amount of power used (e.g., to refresh the RAM for dynamic RAM types) while the device is running, which may prolong battery life. Yet another advantage of the present invention is that the first embodiment of the present invention may provide rich and colorful content on a display screen comparable to that of HTML. Thus, embodiments of the present invention have many advantages and benefits that make them preferably for use on a handheld computer device, especially when compared to HTML files running on an HTML browser.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the processes, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of providing demonstration screen displays on a display screen of a handheld computer device, comprising:
executing a demonstration file on the handheld computer device, wherein the demonstration file includes sets of screen instructions for providing at least two of the screen displays, wherein at least one of the sets of screen instructions includes:
a screen name for identifying the set of screen instructions;
a jump reference to any one of the screen names in the demonstration file; and
at least one of a text anchor element and an image anchor element;
wherein each text anchor element includes:
an opening text anchor tag signifying the beginning of the text anchor element,
a text string content,
an absolute screen position specification for where the text string content is placed on the display screen, and
a closing text anchor tag signifying the end of the text anchor element, and
wherein each image anchor element includes:
an opening image anchor tag signifying the beginning of the image anchor element,
an image file name corresponding to an image file having data for an image therein,
an absolute screen position specification for where the image is placed on the display screen, and
a closing image anchor tag signifying the end of the image anchor element; and
generating and displaying a first graphical user interface on the display screen while executing the demonstration file on the handheld computer device, wherein the first graphical user interface corresponds to a first screen name selected from any one of the screen names, and wherein the first graphical user interface is generated and displayed based on the set of screen instructions identified by the first screen name.

2. The method of claim 1, further comprising:
accepting a first user input via the first graphical user interface, wherein the first user input calls upon a first jump reference selected from a jump reference in the set of screen instructions of the first screen name, the first jump reference being to a second screen name selected from any one of the screen names in the demonstration file;
removing the first graphical user interface from the display screen; and
generating and displaying a second graphical user interface on the display screen, wherein the second graphical user interface corresponds to the second screen name, and wherein the second graphical user interface is generated and displayed based on the set of screen instructions identified by the second screen name.

3. The method of claim 1, wherein each text anchor element further includes at least one of:
a font specification for the text string content, and
a screen width specification for the text string content, the screen width specification providing an instruction as to where the text string content shall be wrapped to a next line.

4. The method of claim 1, wherein the jump reference is embedded in one of the text anchor elements for linking the jump reference to its text string content.

5. The method of claim 1, wherein the jump reference is embedded in one of the image anchor elements for linking the jump reference to its image.

6. The method of claim 5, wherein the image anchor element having the jump reference therein, further includes:
a shape specification for a button area on the image corresponding to the jump reference, and
an absolute screen position specification for defining boundaries of the button area.

7. The method of claim 1, wherein each image anchor element further includes:
an image anchor specification for specifying which location on the image will be placed at the specified absolute screen position for the image.

8. A method of providing demonstration screen displays on a display screen of a handheld computer device, comprising:
executing a demonstration file on the handheld computer device, wherein the demonstration file includes sets of screen instructions for providing at least two of the screen displays, wherein at least one of the sets of screen instructions includes:
a screen name for identifying the set of screen instructions; and
at least one of a text anchor element and an image anchor element;
wherein each text anchor element includes:
an opening text anchor tag signifying the beginning of the text anchor element,
a text string content,
an absolute screen position specification for where the text string content is placed on the display screen, and
a closing text anchor tag signifying the end of the text anchor element; and
wherein each image anchor element includes:
an opening image anchor tag signifying the beginning of the image anchor element,
an image file name corresponding to an image file having data for an image therein,
an absolute screen position specification for where the image is placed on the display screen,
a jump reference linking at least part of the image to any one of the screen names in the demonstration file, and
a closing image anchor tag signifying the end of the image anchor element; and
generating and displaying a first graphical user interface on the display screen while executing the demonstration file on the handheld computer device, wherein the first graphical user interface corresponds to a first screen name selected from any one of the screen names, and wherein the first graphical user interface is generated and displayed based on the set of screen instructions identified by the first screen name;
accepting a first user input via the first graphical user interface, wherein the first user input calls upon a first jump reference selected from a jump reference in the set of screen instructions of the first screen name, the first jump reference being to a second screen name selected from any one of the screen names in the demonstration file;
removing the first graphical user interface from the display screen; and
generating and displaying a second graphical user interface on the display screen, wherein the second graphical user interface corresponds to the second screen name, and wherein the second graphical user interface is generated and displayed based on the set of screen instructions identified by the second screen name.

9. A handheld computer device comprising:
a display screen;
an operating system adapted to execute a demonstration file on the handheld computer device, wherein the demonstration file includes sets of screen instructions for providing at least two screen displays, wherein at least one of the sets of screen instructions includes:
a screen name for identifying the set of screen instructions;
a jump reference to any one of the screen names in the demonstration file; and
at least one of a text anchor element and an image anchor element;
wherein each text anchor element includes:
an opening text anchor tag signifying the beginning of the text anchor element,
a text string content,
an absolute screen position specification for where the text string content is placed on the display screen, and
a closing text anchor tag signifying the end of the text anchor element; and
wherein each image anchor element includes:
an opening image anchor tag signifying the beginning of the image anchor element,
an image file name corresponding to an image file having data for an image therein,
an absolute screen position specification for where the image is placed on the display screen, and
a closing image anchor tag signifying the end of the image anchor element; and
wherein the handheld computer device is adapted to generate and display a first graphical user interface on the display screen while executing the demonstration file, wherein the first graphical user interface corresponds to a first screen name selected from any one of the screen names, and wherein the first graphical user interface is generated and displayed based on the set of screen instructions identified by the first screen name; and
a user input device for allowing a user to interact with the first graphical user interface.

10. The handheld computer device of claim 9, wherein the display screen is a touch-sensitive screen and the user input device includes the touch-sensitive screen.

11. The handheld computer device of claim 9, wherein the user input device includes buttons adjacent to the display screen.

12. The handheld computer device of claim 9, wherein the user input device includes an external keyboard.

13. The handheld computer device of claim 9, wherein the user input device includes a cursor control device adjacent to the display screen.

14. The handheld computer device of claim 9, wherein the user input device includes an external cursor control device.
